(19) United States
(12) Patent Application Publication
(10) Pub. No.: US 2024/0125593 A1
(43) Pub. Date: Apr. 18, 2024

(54) METHOD AND SYSTEM FOR CAPTURING AND PROVIDING DATA FOR A PURCHASE OF AN ITEM OF CLOTHING

(71) Applicant: Sikora AG, Bremen (DE)

(72) Inventor: Harald Sikora, Bremen (DE)

(73) Assignee: Sikora AG, Bremen (DE)

(21) Appl. No.: 18/277,193

(22) PCT Filed: Feb. 10, 2022
(86) PCT No.: PCT/EP2022/053234

§ 371 Date: Aug. 14, 2023

(30) Foreign Application Priority Data
Feb. 16, 2021 (DE) 10 2021 103 578.3

(51) Int. Cl. G01B 11/245; G06Q 30/0601

(52) U.S. Cl. CPC G01B 11/245; G06Q 30/0621; G06Q 30/0631; G06Q 30/0643; G01B 2210/54

(57) ABSTRACT

The invention relates to a method for capturing and providing data for a purchase of an item of clothing, in particular an online purchase of an item of clothing, comprising the following steps:
a clothed person is irradiated with terahertz radiation by means of at least one transmitter for terahertz radiation and terahertz radiation reflected by the person is received by at least one receiver for terahertz radiation,
body measurement data of the person are determined from the terahertz radiation received by the at least one receiver.
   The invention also relates to a corresponding system.

### CROSS REFERENCE TO RELATED INVENTION

This application is a national stage application pursuant to 35 U.S.C. § 371 of International Application No. PCT/EP2022/053234, filed on Feb. 10, 2022, which claims priority to, and benefit of, German Patent Application No. 10 2021 103 578.3, filed Feb. 16, 2021, the entire contents of which are hereby incorporated by reference.

### FIELD OF TECHNOLOGY

The invention relates to a method and to a system for capturing and providing data for a purchase of an item of clothing, in particular an online purchase of an item of clothing.

### BACKGROUND

Online shopping for items of clothing via corresponding websites or applications (apps) from manufacturers or retailers for items of clothing is becoming increasing popular. The purchase of items of clothing is thus possible in a simple and convenient manner from home. However, one disadvantage is that it is not possible to try on the items of clothing before purchasing them. It is not possible to check the size of the items of clothing. Therefore, customers often order several of the same items of clothing in different sizes. The customer then tries on the different sizes at home and returns items of clothing that do not fit. This results in additional effort in connection with shipping, which is also undesirable from an environmental point of view.

Suppliers of items of clothing for online purchase attempt to counteract this problem with additional information, for example that a particular item of clothing is big or small for the specified size, or by making reference to items of clothing of other brands for which the customer may know the size that fits them. Although this additional information provides the customer with additional assistance, the above-mentioned problem is not sufficiently resolved.

In addition to the correct size, the customer only assesses the item of clothing itself when wearing same after receiving the delivered item of clothing. Therefore, even if the size is correct, there are often returns due to dissatisfaction, for example with regard to the cut of the item of clothing.

DE 20 2018 105 003 U1 proposes predicting further body measurement data based on some body measurement data provided by a customer and, on this basis, selecting suitable items of clothing for the customer. However, this is problematic, firstly in that body measurement data must first be captured and provided by the customer. This often results in errors, and therefore the body measurement data provided by the customer are either incorrectly captured or include only rudimentary data, for example body size and weight. Predicting further body measurement data based on such body measurement data is often difficult and fraught with errors. In particular, individual features of the physique of a person are poorly taken into account.

DE 20 2015 101 014 U1 and DE 10 2019 123 458 A1 propose recording the body of a person by means of a camera from various directions and deducing the clothing size of the person optionally based on reference objects. This makes it possible, for example, to determine the body size and body circumference of a person. However, it is difficult to accurately capture body measurement data by means of photographic recordings. This is not least due to the clothing worn by the person when the photos are taken.

WO 2017/203262 A2 discloses providing suitable items of clothing for a user by means of neural networks based on data provided by the user, for example body measurements, location, age or ethnicity and based on selected items of clothing. The use of neural networks for adapting items of clothing to body measurement data, for example a three-dimensional body model, is also known from WO 2020/098982 A1. Both methods and systems also suffer from the problem of the body measurement data potentially being inaccurately captured, and therefore the further selection of suitable items of clothing is also fraught with errors.

Proceeding from the explained prior art, the object of the invention is to provide a method and a system of the type mentioned at the outset by means of which data for a purchase of an item of clothing, in particular an online purchase of an item of clothing, can be captured in a more reliable manner and provided for purchase in such a way that the disadvantages explained above can be avoided.

### BRIEF SUMMARY OF THE INVENTION

With regard to a method of the type mentioned at the outset, the invention achieves the object by means of the following steps: (i) a clothed person is irradiated with terahertz radiation by means of at least one transmitter for terahertz radiation and terahertz radiation reflected by the person is received by at least one receiver for terahertz radiation; and (ii) body measurement data of the person are determined from the terahertz radiation received by the at least one receiver.

The invention also achieves the object by means of a system of the type mentioned at the outset, comprising at least one transmitter for terahertz radiation for irradiating a clothed person with terahertz radiation, as well as at least one receiver for terahertz radiation for receiving terahertz radiation reflected by the person, further comprising an evaluation apparatus that is designed to determine body measurement data of the person from terahertz radiation received by the at least one receiver.

The disclosed device and associated method are based on the idea of measuring a person by means of terahertz radiation, in particular in a scanning process, in order to thus reliably obtain body measurement data in order, for example, to select an item of clothing. Terahertz radiation, also referred to as radar radiation or millimeter wave radiation, is electromagnetic radiation of which the frequency may, for example, be in the range of from 10 GHz to 3 THz. Terahertz radiation of this kind penetrates clothing and is reflected, in particular, on the surface of the skin of the body. As a result, even when measuring a clothed person, a reliable determination of body measurement data that is independent of the clothing worn is possible quickly and in a manner that is harmless to health. According to the invention, for this purpose, at least one transmitter is provided for emitting the terahertz radiation onto the person and at least one receiver is provided for receiving terahertz radiation reflected by the person. The at least one transmitter and the at least one receiver may be arranged substantially in the same location. They may, for example, be combined with one another in at least one transceiver. If multiple transmitters and multiple receivers are provided, one transmitter and receiver may in each case form a pair, i.e. the transmitters and receivers may be arranged in pairs. Relevant body measurement data of the person can be determined from the terahertz radiation reflected by the person. For this purpose, for example, a propagation time measurement of the emitted terahertz radiation received again after the reflection can take place, as a result of which the distance between the transmitter and/or receiver and the reflecting surface, in this case the surface of the skin of the person's body, can be precisely deduced. In particular if multiple transmitters and multiple receivers are provided, a person can be measured completely with regard to their size. If the terahertz radiation is emitted onto the person from different directions and reflected terahertz radiation is received again, a substantially complete three-dimensional profile or rather three-dimensional model of the body of the measured persons can be created. In this way, all relevant body measurement data can be determined for the selection of a suitable item of clothing. Body measurement data of this kind includes, for example, head circumference, neck circumference, shoulder width, arm circumference, chest and bust measurement, bust point, waist or abdominal size, hip size, sleeve length, upper body length, leg length, wrist circumference, etc. The clothing size of the person can be deduced from the measurement according to the invention. However, it is also conceivable that the body of the person is captured largely completely and three-dimensionally, such that items of clothing can be adapted better. Here, it is also conceivable to create a three-dimensional module, for example a CAD module, by means of which adaptation of items of clothing to different body sizes is possible.

It is possible to identify and suggest to the person an item of clothing in a size that is suitable with respect to the determined body measurement data based on the determined body measurement data and an operator specification of the person. Then, based on the determined body measurement data and based on an operator specification of the person, an item of clothing that is optimal with respect to the determined body measurement data and the operator specification of the person can be identified and suggested to the person. The operator specification, which may for example be input by the person online, for example on a website, or in an application on a computer or mobile device such as a tablet or smartphone, may in the simplest case include only the specification of the type of the item of clothing, i.e., for example, a shirt, blouse, sweater, top, pants, jacket, coat, etc. However, the operator specification may also include further specifications, for example, color, material, cut, etc., of the item of clothing. According to the invention, one or more items of clothing that meet the criteria of the operator specification and the determined body measurement data can be selected from items of clothing available for purchase by means of corresponding software based on the operator specification and in consideration of the determined body measurement data. Said item or items of clothing can then be suggested to the person, again online, for example on a website used by the person or in an app used by the person on a computer or mobile device.

On account of the determination according to the invention of the body measurements, in particular profile or three-dimensional representation of the body of the person, targeted provision of an optimally sized item of clothing is possible based on the operator specification of the person. Unlike in the case of optical recordings by means of a camera, for example, as explained with regard to the prior art, which by their nature cannot penetrate through clothing and intermediate spaces of the clothing, the use of terahertz radiation according to the invention allows for reliable determination of the actual body measurement data. The disadvantages explained at the outset with reference to the prior art can therefore be overcome.

The at least one transmitter and receiver for terahertz radiation may be located at another location than, for example, a retailer or manufacturer of items of clothing. For example, the at least one transmitter and receiver could be located in a shopping mall or, for example, a store of a retailer or manufacturer or, for example, at an airport. The person can then have the measurement done. The corresponding measurement data may, for example, be evaluated by means of an evaluation apparatus located at the location of the measurement or at another location in order to determine the body measurement data. This evaluation can take place by means of a computer program. The correspondingly determined body measurement data can be made available to the person, for example on a website or in an application on a computer or mobile device. The person can then use the determined body measurement data for multiple purchases at different manufacturers or retailers, irrespective of where the measurement was carried out. In particular, it is possible that the person has the body measurement data determined at a first location and at a first time by means of the method and/or system according to the invention. For example, at a later second time and/or, for example, at another second location, the person may then, for example, physically input an operator specification in a store or on the go in an app or online store and, on this basis, the item of clothing can then be suggested to the person in the manner explained above on the basis of the previously determined body measurement data. Of course, the input of the operator specification and the subsequent suggestion of an item of clothing could also take place at the same location as the determination of the body measurement data, for example in a shopping mall or airport in which the determination of the body measurement data also takes place. It is possible for the body measurement data to be determined as desired and, optionally, in return for separate payment of the person by means of a terahertz scanning system already provided, for example, in airports for security checks. The payment can in this case be done, for example, online or in cash. It would also be conceivable to provide vouchers by means of the shops offering corresponding items of clothing. Corresponding reward programs would of course also be conceivable. The evaluation apparatus provided in the system according to the system may accordingly comprise multiple evaluation sub-apparatuses that may be arranged at different locations or be realized by different computer programs or applications. For example, a first evaluation sub-apparatus may control the terahertz measurement and determine the body measurement data from the measurement data, whereas a second evaluation sub-apparatus identifies and suggests the suitable item of clothing based on the body measurement data and the operator specification.

In an embodiment, multiple items of clothing can also be suggested to the person, from which items of clothing the person can select and/or which items of clothing the person can combine in a desired manner. Said multiple items of clothing may be different types of items of clothing, for example a pair of pants and a shirt, or items of clothing of the same type, but in different sizes in the event of multiple possible sizes, in different colors, of different materials, or with different cuts, or the like. It is also possible to suggest to the person further items of clothing that can be suitably combined with an item of clothing selected by the person or with an item of clothing suggested to the person based on the operator specification and the body measurement data.

According to one embodiment, terahertz radiation emitted by the least one transmitter and passing the person can be received by at least one further receiver for terahertz radiation arranged opposite the at least one transmitter, wherein body measurement data of the person are determined from the terahertz radiation received by the at least one further receiver. According to another, alternative or additional embodiment, further terahertz radiation emitted by at least one further transmitter for terahertz radiation arranged opposite the at least one transmitter and passing the person can be received by the at least one receiver, wherein body measurement data of the person are determined from the further terahertz radiation received by the at least one receiver. By means of these embodiments, in particular the body boundaries can be captured in a more reliable manner.

According to another embodiment, some of the terahertz radiation emitted by the at least one transmitter can be reflected by at least one reflector located opposite the transmitter, and terahertz radiation reflected by the at least one reflector can be received by the at least one receiver, wherein body measurement data of the person can be determined from the terahertz radiation received by the at least one receiver, reflected by the at least one reflector. The reflector reflects a proportion of terahertz radiation that is sufficient for the evaluation. Depending on the reflectance of the reflector, greater or lesser losses of intensity may occur. If this is acceptable for the evaluation, a lower reflectance may potentially be sufficient, as a result of which the reflector can be designed in a more cost-effective manner. For example, it may be sufficient to use a surface of a terahertz radiation meter already provided as the reflector, for example of a terahertz radiation meter already present in the security area of an airport, for example.

By providing one or more reflectors arranged opposite the at least one transmitter and, in particular, also opposite the at least one receiver, for example the at least one transceiver, terahertz radiation passing the body of the person can be reflected by the reflector and received again by the receiver. In particular, the body boundaries or body edges can be captured much more precisely based on the terahertz radiation that has just passed the body than based solely on the terahertz radiation reflected by the body. This applies, in particular, for narrow points of the body, for example at the armpits or in the crotch area. As a result, body measurement data of the person can be captured more accurately and the selection of an item of clothing can take place in a more targeted manner. In particular if the at least one transmitter is moved along a straight line in order to measure the person, or if multiple transmitters are arranged along a straight line, only a relatively small region of the body can be measured by means of distance measurement, since the majority of the terahertz radiation is reflected, in particular, in peripheral regions of the body in a direction in which it is no longer received by the at least one receiver. This problem occurs less in the case of transmitters and receivers or, alternatively, transceivers displaced along a circular path or circular arc-shaped path around the person. However, this problem does still occur due to the irregular shape of the surface of the body. This can be effectively addressed by means of the above-mentioned embodiment.

According to another embodiment, the reflector may comprise a retroreflector. Retroreflectors reflect incident radiation, in this case terahertz radiation, substantially back in the direction from which the radiation came, irrespective of the angle of incidence. By using retroreflectors, even more comprehensive measurement of a person is made possible. This applies, for example, in the case of curved reflectors or, alternatively, transmitters and receivers that are arranged or displaceable along a curved path.

According to another embodiment, some of the terahertz radiation reflected by the at least one reflector may strike a side of the person that faces away from the at least one transmitter, be reflected by the person, and be received by the at least one receiver after being reflected again by the at least one reflector. In this way, the rear side of the person facing away from the at least one transmitter can also be measured by means of corresponding distance measurements in a constructively particularly simple manner without providing opposing transmitters and receivers. By suitably orienting the at least one transmitter, it is possible, for example, for terahertz radiation to be directed past the reflector obliquely to the body of the person, such that said radiation strikes the side of the person's body that faces away from the at least one transmitter after being reflected on the reflector, and to be received by the correspondingly oriented at least one receiver after being reflected on the body and then reflected again on the reflector. The at least one transmitter and/or the at least one receiver may, for example, be arranged so as to be displaceable in order to adjust the orientation. Of course, it would also be conceivable for this purpose to direct terahertz radiation by means of suitable further reflectors onto the side of the person's body that faces away from the at least one transmitter.

Furthermore, boundary lines of the person's body, in particular at narrow points of the person's body, such as under the armpits or in the crotch area, can be determined as body measurement data from the terahertz radiation received by the at least one receiver and/or by the at least one further receiver, for example reflected by the at least one reflector.

A movement of the person's body, for example a movement of the person's thorax during breathing, can be detected from a temporal change in the determined boundary lines of the person's body. The detected movement can be taken into account when the body measurement data are determined. This, in turn, is made possible in that the edges of the body, their temporal change, and thus the breathing movement can be captured more precisely by means of the evaluation of the received terahertz radiation. In this way, distortions of the body measurement data caused by a movement of the body are prevented.

For even more accurate capturing of the boundary lines of the body or rather edges of the body, a diffraction pattern of the terahertz radiation diffracted at boundary lines of the person's body and reflected by the reflector can be analyzed in order to determine the body measurement data of the person. Terahertz radiation is diffracted at boundary lines of the body, wherein the diffraction pattern is imaged on the reflector and/or reaches the receiver. By means of a diffraction analysis, the boundary lines and thus the body measurement data can be determined even more precisely.

In the case of transmitters and receivers rotating around the person, it is possible that the at least one reflector also rotates around the person. However, it is in turn also possible to arrange multiple reflectors so as to be distributed over the circumference of the person, according to the number and arrangement of the transmitters and receivers. A, for example horizontal, movement of the transmitter and receiver on the one hand and of the reflector on the other hand is also possible. As a result, body measurement data can be captured even better. It would also be conceivable, for example, for the at least one reflector to comprise an opening for the exit and optionally the entry of terahertz radiation from a transmitter and/or receiver.

Instead of a reflector, it is also possible, as has already been explained, to provide at least one further receiver for terahertz radiation opposite the at least one transmitter, which further receiver receives terahertz radiation that passes the person's body. Said further receiver would replace the reflector by directly receiving the terahertz radiation passing the boundary lines or rather edges of the body. All embodiments explained above in relation to the reflector are then in turn possible, wherein the further receiver in each case replaces the reflector.

According to another embodiment, multiple transmitters for terahertz radiation may be provided for irradiating a clothed person with terahertz radiation and multiple receivers for terahertz radiation may be provided for receiving terahertz radiation reflected by the person, wherein the multiple transmitters are arranged at different heights and wherein the multiple receivers are arranged at different heights. An arrangement of the pairs of transmitters and receivers in rows one above the other is conceivable, for example. In this way, the person's body can be fully captured over its entire height. Of course, a displacement of at least one transmitter and/or at least one receiver in terms of height in order to fully capture the person's body would also be conceivable.

According to another embodiment, multiple transmitters for terahertz radiation may be provided for irradiating a clothed person with terahertz radiation and multiple receivers for terahertz radiation may be provided for receiving terahertz radiation reflected by the person, wherein the multiple transmitters are arranged at different angular positions around a capturing region for the person and wherein the multiple receivers are arranged at different angular positions around a capturing region for the person. As already explained, the transmitters and receivers may in each case be provided in pairs and for example, in each case as a pair at the same location, for example in each case integrated as transceivers. The capturing region is a region in which the person to be measured stands during the irradiation with terahertz radiation. Said capturing region may, for example, be marked on the floor in a measuring space. In the case of the embodiment mentioned above, multiple pairs of transmitters and receivers arranged, for example, in rows one above the other may be arranged at the same angular distances around the capturing region, for example along a circular path. For example, three transmitter/receiver rows of this kind may be arranged in each case at an angle of 120°. This allows for irradiation and thus capturing of the body measurement data from, for example, three sides over the circumference. As a result, the body and thus the body measurement data thereof can be reliably captured from various sides and thus fully captured within the scope of a 3D model.

According to another embodiment, at least one transmitter for terahertz radiation for irradiating the clothed person with terahertz radiation and at least one receiver for terahertz radiation for receiving terahertz radiation reflected by the person may be rotatable around a capturing region for the person. Again, it may for example be an arrangement in rows in a vertical direction of multiple pairs of transmitters and receivers or, alternatively, transceivers. In the above-mentioned embodiment, said arrangement in rows may, for example, be rotatable around the capturing region along a circular path. However, it would also be conceivable, for example, for a transmitter that rotates around the person and for a receiver that rotates around the person, for example in the form of a transceiver, to also be moved in terms of height during the rotational movement and thus to travel different heights. As a result, the use of an arrangement in rows of multiple transmitters and receivers would not be required. Of course, instead of a rotating transmitter and receiver, a stationary transmitter and receiver may be used, while the person is located on a rotating surface, for example a rotating disk. This allows for irradiation and thus capturing of the body measurement data from all sides over the circumference of the person's body.

Of course, multiple transmitters for terahertz radiation may also be provided for irradiating a clothed person with terahertz radiation and multiple receivers for terahertz radiation may be provided for receiving terahertz radiation reflected by the person, wherein the multiple transmitters and/or the multiple receivers are arranged along a straight line along the capturing region for the person. Of course, it would also be conceivable to move the at least one transmitter and the at least one receiver along a straight line of this kind.

According to another embodiment, changes to an item of clothing to be suggested to the person can be calculated on the basis of the determined body measurement data in order to improve the fit of the item of clothing for the person Changes of this kind can be provided in order to adapt to individual body features of the person. Said changes may, for example, be the shortening of sleeves or pant legs or, for example, the shortening of skirts. Equally, said changes may be tucks in order, for example, to better adapt the cut of the item of clothing to the determined body measurement data of the person.

According to the invention, it is of course also conceivable to suggest a custom-made item of clothing based on the determined body measurement data of the person. For example, it is conceivable to create a three-dimensional model for items of clothing that fit the person based on a three-dimensional body model of the person created by means of the invention. As a result, preferably automated or automatic manufacture of items of clothing for the person with a precise fit is possible, as in the case of a custom-made product. By means of such automatic determination possible according to the invention of the three-dimensional body model of the person, of a three-dimensional model of fitting items of clothing, and of automated, preferably automatic production of at least one item of clothing on this basis, the advantages of custom production can be achieved with significantly reduced costs.

According to another embodiment, a movement of the person can furthermore be detected during the irradiation with terahertz radiation by means of at least one camera. The system according to the invention then comprises a correspondingly designed camera. It is also conceivable to detect a movement of the person during the irradiation with terahertz radiation from a frequency shift of the terahertz radiation received by the at least one receiver, which frequency shift is captured during the irradiation with terahertz radiation. Such a frequency shift occurs according to the Doppler effect if, during the measurement, the distance between the person or rather the surface reflecting the terahertz radiation and the transmitter/receiver changes. If the person moves during the measurement with terahertz radiation, this can lead to inaccuracies with regard to the profile or rather the captured body measurement data. Therefore, according to the embodiments explained, such changes in distance due to a movement of the person can be captured. The detected movement can then be taken into account during determination of the body measurement data. In particular, the body measurement data can be computationally corrected on the basis of the captured movement.

Of course, it would also be conceivable to implement measures that would prevent a movement of the person during the measurement as far as possible. For example, supports or handles could be provided on which the person can support themselves or which said person can hold on to with their hands during the measurement.

According to another embodiment, a photo, at least of the head of the person, may furthermore be created by means of at least one camera. Although terahertz radiation can be used to reliably capture, in particular, the surface of the skin of the person's body, no photographic recordings of, for example, the person's face can be made. The person's hair cannot generally be detected with terahertz radiation either. This can be done according to the above-mentioned embodiment using an optical camera, for example a digital camera. Of course, multiple cameras may in turn also be provided, which are arranged, for example, one above the other or are arranged, for example, at different angular positions around a capturing region for the person. It would also be conceivable to provide at least one camera, for example together with transmitters and receivers for terahertz radiation, so as to be rotatable around a capturing region for the person. In this way, photos can in turn be taken from different directions of the person, such that, for example, the head with the hairstyle of the person can also be recorded from the rear.

According to another embodiment, it is possible to determine further body measurement data of the person based on the photo created, which data are taken into account during identification of a suggested item of clothing. For example, a photo taken by means of an optical camera could help to determine the shoe size of the person or, for example, the shape of a hand, the thumbs and fingers of which can hardly be resolved with terahertz radiation. Said further determined body measurement data can also be taken into account when identifying and suggesting an item of clothing.

According to another embodiment, a body model of the person can be created on the basis of the determined body measurement data, and a visualization can be created, wherein, in the visualization, the item of clothing suggested to the person is represented in the state worn by the body model. The body model can, in particular, be a 3D body model. Accordingly, the visualization can also be a 3D visualization. The visualization is displayed to be viewed by the person, for example on a website or in an app on a computer or mobile device such as a tablet or smartphone. The visualization offers the customer the opportunity to view the item of clothing suggested to them in the state worn by a body model corresponding to their own body and thus, for example, to realistically check for themselves the cut of the item of clothing without even trying it on. By means of a visualization of this kind, the person can also view different items of clothing one after the other and thus compare them with one another, similar to how this is possible in a store by trying on different items of clothing. Any calculated changes for an improved fit of the item of clothing can, of course, also be displayed in the visualization.

For a particularly realistic check, the visualization can be supplemented with the photo created by means of the at least one camera, said photo in particular being of the person's head. If, for example, there is a photo of the head and hairstyle of the person, this can be integrated into the visualization with the body model and the suggested item of clothing, such that the customer gets an even more realistic idea of the item of clothing being worn. It would also be conceivable here, for example, to display different hairstyles in the visualization in a manner controllable by the person in order to give the person an even better impression of the item of clothing when worn.

According to another embodiment, in the visualization, the body model with the item of clothing worn by the body model may be rotatable and/or may be displayable against different backgrounds and/or further items of clothing may be displayable in the state worn by the body model. On account of these embodiments, even better viewing options result for the person against backgrounds that suit the relevant item of clothing and thus an even better basis for making a decision with regard to the selection of an item of clothing. Merely by way of example, backgrounds such as an evening event, a beach, a spring meadow, a ski slope, a home, etc., can be mentioned. The visualization may be controllable by the person, for example by means of a corresponding control function on the website or in an app on a computer or mobile device. For example, in this way, the person can select different backgrounds and/or rotate the body model in order to thus obtain views from different directions. Further items of clothing displayed in the visualization may be items of clothing provided in addition to the item of clothing suggested to the person, for example further suggestions based on the previously suggested item of clothing. If multiple items of clothing are suggested to the person based on the operator specification of said person, said items of clothing can be displayed in the visualization optionally together or one after the other by means of a corresponding selection of the person.

According to another embodiment, a payment process can be initiated for an item of clothing selected by the person. This also applies, accordingly, for a subsequent delivery process, in particular in the case of an online purchase. Again, this can take place in the usual manner on a website or in an app.

The method according to the invention can be carried out by means of a computer program. The method may therefore be a computer-implemented method. Accordingly, the system according to the invention, in particular the evaluation apparatus, but also the at least one transmitter for terahertz radiation and the at least one receiver for terahertz radiation, can be controlled by means of a computer program. A computer program of this kind may, for example, be an application (app). The computer program may, or example, be executed on a computer or mobile device such as a tablet or smartphone. As already explained, any visualization may be displayed on the computer or mobile device and controlled by the person. The computer program may also form the evaluation apparatus. As already explained, the evaluation apparatus may also be realized by multiple computer programs. The evaluation apparatus may also be a computer on which the computer program is executed.

The method according to the invention may be carried out using the system according to the invention. Accordingly, the system according to the invention may be suitable for carrying out the method according to the invention.

### BRIEF DESCRIPTION OF THE DRAWINGS

Exemplary embodiments of the invention are explained below in greater detail using schematic drawings.

FIG. 1 illustrates a perspective view of an embodiment of a system for capturing and providing data for a purchase of an item of clothing.

FIG. 2 illustrates a perspective view of another embodiment of a system for capturing and providing data for a purchase of an item of clothing.

FIG. 3 illustrates a perspective view of another embodiment of a system for capturing and providing data for a purchase of an item of clothing.

FIG. 4 schematically illustrates another embodiment of a system for capturing and providing data for a purchase of an item of clothing from a top view.

FIG. 5 illustrates the system from FIG. 4 in second operating state.

FIG. 6 illustrates the system from FIG. 4 in a third operating state.

FIG. 7 schematically illustrates another embodiment of a system for capturing and providing data for a purchase of an item of clothing from a top view.

The same reference numbers refer to the same objects in the figures unless indicated otherwise.

### DETAILED DESCRIPTION OF THE INVENTION

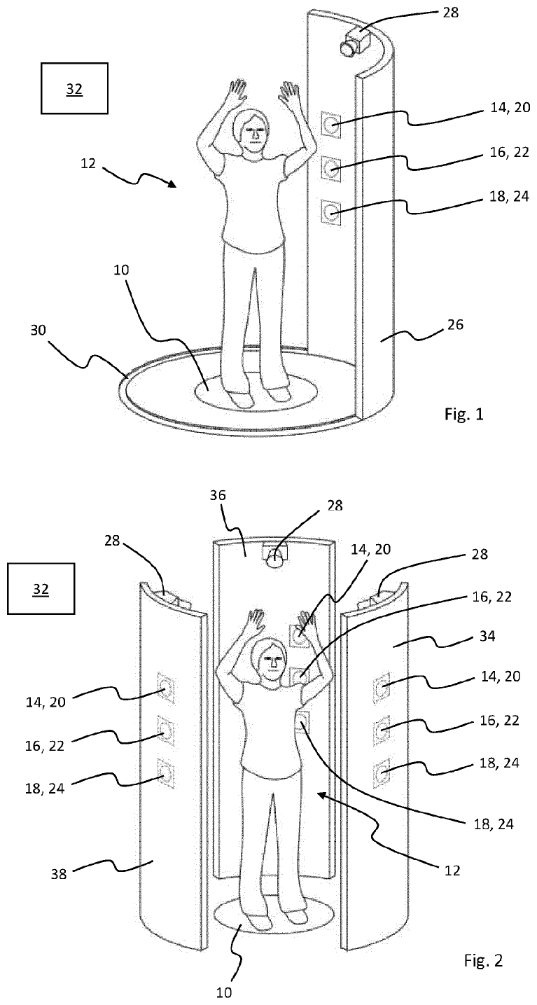

In FIG. 1, a capturing region 10 in which a clothed person 12 is standing is marked on the floor of a space. In the example shown, the system comprises a plurality of transmitters 14, 16, 18 for terahertz radiation and receivers 20, 22, 24 for terahertz radiation arranged in a row one above the other. In the example shown, the transmitters 14, 16, 18 and receivers 20, 22, 24 are arranged in pairs substantially at the same location, for example integrated as transceivers. In the example shown, three pairs of transmitters 14, 16, 18 and receivers 20, 22, 24 are arranged in a row one above the other. It should be understood that fewer or more of such pairs of transmitters 14, 16, 18 and receivers 20, 22, 24 may be provided. In FIG. 1, the transmitters 14, 16, 18 and receivers 20, 22, 24 are integrated into a measuring column 26 in the shape of a cylindrical shell. Moreover, a camera 28, in the present case a digital camera 28, is arranged at the upper end of the measuring column 26. In the example shown in FIG. 1, the measuring column 26, and with it the transmitters 14, 16, 18 and receivers 20, 22, 24 as well as the camera 28, can be rotated around the person 12 along a circular path 30 during a measurement. It should be understood that, instead, it is also possible, for example, for the capturing region 10, for example in the form of a capturing disk, to be rotated during a measurement. The transmitters 14, 16, 18 and receivers 20, 22, 24 could then be designed to be stationary and yet the person 12 could still be captured entirely.

An evaluation apparatus 32, which may be realized by a computer program, is provided for executing the method according to the invention by means of the system shown on FIG. 1. For this purpose, the transmitters 14, 16, 18 emit terahertz radiation onto the person 12 located in the capturing region 10. The terahertz radiation is reflected by the body of the person 12, in particular the surface of the skin, and reflected terahertz radiation arrives back at the receivers 20, 22, 24. In this way, distances between the transmitters 14, 16, 18 and/or receivers 20, 22, 24, the position of which in space is known, and the person 12 can be determined, for example, from a propagation time measurement. During the measurement, the measuring column 26 is rotated around the person 12 along a circular path 30, such that the distance to the surfaces of the person 12 is measured from all sides. A three-dimensional body profile of the person 12 is calculated by means of the evaluation apparatus 32 from the measurement data received from the receivers 20, 22, 24, from which three-dimensional body profile relevant body measurement data for determining the correct size of an item of clothing are determined.

The person 12 may, for example, input an operator specification for selecting an item of clothing, for example the type of an item of clothing, such as a shirt or a pair of pants, and, if applicable, further specifications such as color, material, cut, or the like, on a website or in an app on a computer or mobile device. Based on the operator specification of the person 12 and based on the previously determined body measurement data, an item of clothing that is suitable with respect to the determined body measurement data and to the operator specification is identified and suggested to the person 12 by means of the evaluation apparatus 32.

For this purpose, a three-dimensional visualization in which a three-dimensional body model of the person 12 with the suggested item of clothing is displayed can be created by means of the evaluation apparatus 32. Moreover, during the measurement, one or more photos can be taken by means of the camera 28, in particular of the head of the person 12. Using these photos, the body model can be supplemented in the visualization with the head of the person 12. The visualization can again be displayed to the person 12 on a website or in an app on a computer or mobile device and the person 12 can, for example, rotate the visualization or show same against different backgrounds. Furthermore, the person 12 can select different items of clothing that are displayed in the visualization for selection. Moreover, a movement of the person 12 during the scanning process can be detected, for example by means of a camera 28 or on the basis of a potential compression or stretching of the frequency of the terahertz radiation, and taken into account during determination of the body measurement data.

If, during identification of an item of clothing, required changes are determined by means of the evaluation apparatus 32 in order to achieve an improved fit of the item of clothing for the body shape of the person 12, changes of this kind can be calculated by means of the evaluation apparatus 32 and already displayed in the visualization. It would also be conceivable to suggest a custom-made item of clothing to the person 12 based on the determined body measurement data and to display this in the visualization.

Subsequently, a payment process can be initiated on the basis of an item of clothing selected by the person 12, for example again on the website or in an app on a computer or mobile device, and the item can be prepared for shipment to the person 12 within the scope of an online purchase.

FIG. 2 shows a further exemplary embodiment which largely corresponds to the exemplary embodiment according to FIG. 1. It differs merely with respect to the design of the measuring device for determining the body measurement data of the person 12. In the exemplary embodiment according to FIG. 2, three measuring columns 34, 36, 38 are provided which are in the shape of a cylindrical shell and which, unlike the measuring column 26 according to FIG. 1, are not movable, in particular not rotatable, and which are arranged around the capturing region 10 at equal angular distances on a circular path. Each of the measuring columns 34, 36, 38 again supports a series of transmitters 14, 16, 18 for terahertz radiation and receivers 20, 22, 24 for terahertz radiation arranged in pairs in rows one above the other. The transmitters 14, 16, 18 and receivers 20, 22, 24 arranged on the inner faces of the measuring columns 34, 38 and concealed in FIG. 2 are shown by way of dashed lines in FIG. 2 for illustrative purposes. Equally, each measuring column 34, 36, 38 in turn supports a camera 28, in particular a digital camera 28.

In the exemplary embodiment according to FIG. 2, the body measurement data of the person 12 are determined in that the transmitters 14, 16, 18 emit terahertz radiation onto the person 12 from three different circumferential directions, which terahertz radiation is then received in each case by the receivers 20, 22, 24 after being reflected on the body of the person 12. In this way, too, a substantially complete body profile of the person 12 can be recorded. The further processing of the body measurement data determined in this manner can take place in the manner explained with reference to FIG. 1.

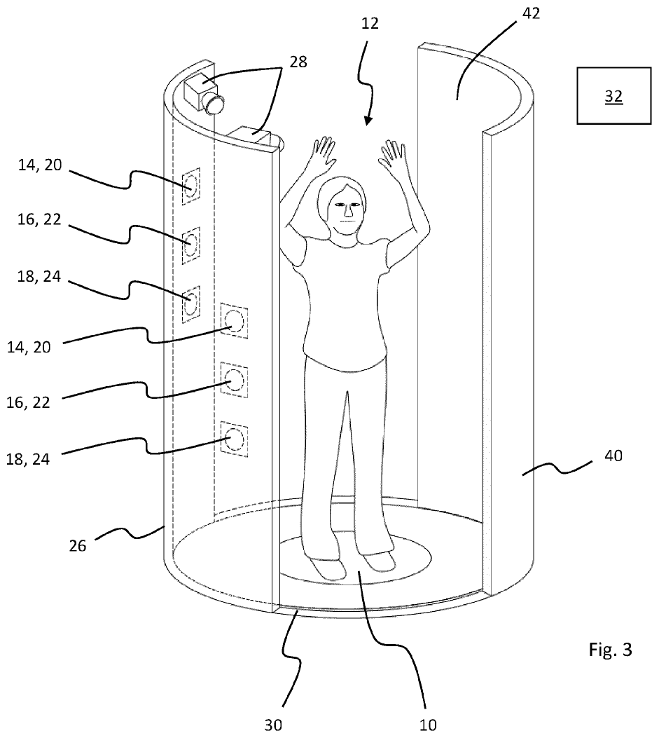

In FIG. 3, another exemplary embodiment is shown, which has a similar design to the exemplary embodiment from FIG. 1. In the exemplary embodiment according to FIG. 3, a further series of transmitters 14, 16, 18 and receivers 20, 22, 24 as well as a further camera 28 are provided. Furthermore, a complementarily formed measuring column 40, the inner surface 42 of which is designed as a reflector for terahertz radiation, is arranged opposite the measuring column 26. If the measuring column 26 is designed to be rotatable, this also applies to the measuring column 40, such that the measuring column 26 and the measuring column 40 are opposite one another at all times.

Terahertz radiation emitted by the transmitters 14, 16, 18 and passing the body of the person 12 is reflected back to the receivers 20, 22, 24 by the reflector 42. Boundary lines of the body of the person 12 can be determined as further body measurement data from the terahertz radiation reflected by the reflector 42. This improves the capturing of the body measurement data, in particular at narrow points on the body of the person 12, such as the armpits or in the crotch area. On this basis, too, a movement of the person 12 can be recognized better. A diffraction pattern of terahertz radiation diffracted at boundary lines of the body of the person 12 and reflected by the reflector 42 can also be analyzed in order to determine the further body measurement data of the person 12.

As explained at the outset, it would also be conceivable to provide further receivers for terahertz radiation on the measuring column 40 instead of the reflector 42, which receivers directly receive the terahertz radiation passing the body of the person 12. The evaluation and determination of the further body measurement data can take place here in the manner explained with reference to the reflector.

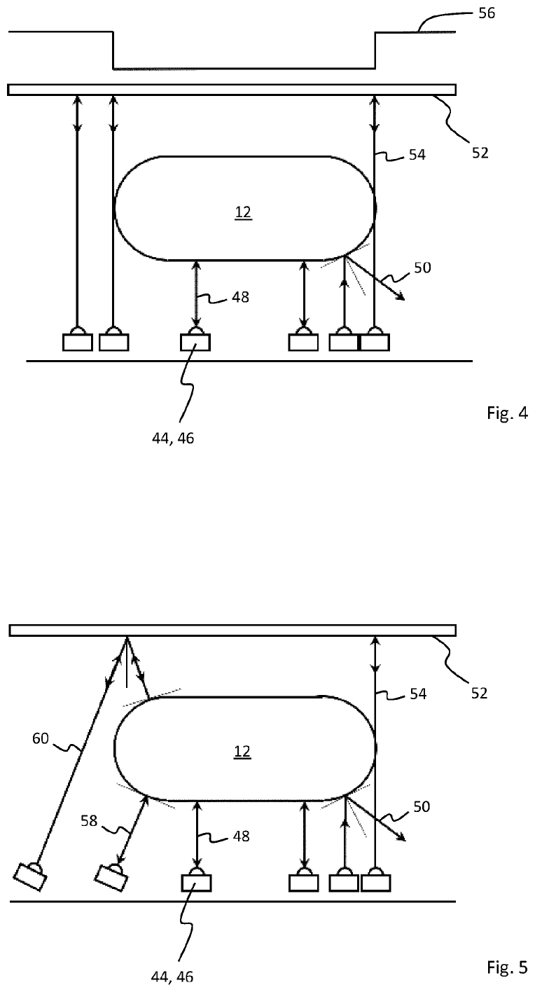

Of course, the embodiment explained with reference to FIG. 3 with an additional reflector or receiver is also conceivable in the case of the exemplary embodiment according to FIG. 2. Then, a reflector or, again, a further receiver for terahertz radiation may be provided opposite at least one of the measuring columns 34, 36, 38.

Whereas in the exemplary embodiments according to FIGS. 1 to 3 the transmitters and/or receivers are arranged along a circular path or designed to rotate, FIGS. 4 to 6 show an exemplary embodiment with transmitters and receivers that are arranged or, alternatively, movable along a straight line.

In FIG. 4, a person 12 is represented very schematically in a view from above. A transmitter 44 and a receiver 46 for terahertz radiation are located on one side of the person 12. The transmitter 44 and the receiver 46 are designed to be integrated as a transceiver, for example. In FIG. 4, the transmitter 44 and the receiver 46 are shown in multiple positions arranged along a straight line for illustrative purposes. For this purpose, the transmitter 44 and the receiver 46 can travel along said straight line. However, it would of course also be conceivable for multiple transmitters 44 and transceivers 46 or, alternatively, transceivers, to be arranged along the straight line. Terahertz radiation emitted by the transmitter 44 and received by the receiver 46 is illustrated in each case by means of an arrow 48. Depending on the position of the transmitter 44 and receiver 46, the terahertz radiation is reflected on the surface of the body of the person 12 and arrives back at the receiver 46. However, as illustrated in FIG. 4 by the arrow 50, the terahertz radiation emitted by the transmitter 44 is reflected depending on a curvature of the surface of the body in a direction in which it is no longer received by the receiver 46. As a result, the measurement, in particular, of the outer boundaries of the body of the person 12 is made difficult or is not possible. In fact, only a relatively small region of the surface of the body remains, which generates an echo of the terahertz radiation that can be evaluated for the measurement.

In FIG. 4, a reflector 52 for terahertz radiation that extends along a straight line or straight plane is further arranged opposite the transmitter 44 and the receiver 46. As illustrated by way of example in FIG. 4 by the arrow 54, terahertz radiation emitted by the transmitter 44, upon reaching the outer edge of the surface of the body of the person 12, passes by the person 12 so as to arrive at the reflector 52 and is reflected back thereby to the receiver 46. At the reference sign 56, FIG. 4 schematically shows a resulting intensity curve along the straight line which is traveled by the transmitter 44 and the receiver 46 during the transverse movement or, alternatively, along which multiple transmitters 44 and multiple receivers 46 are arranged. A jump in intensity can be seen in each case at the boundary lines of the person 12, by means of which the width of the body 12, in particular, can be reliably determined.

FIG. 5 shows another possible embodiment of the system shown in FIG. 4, in which the transmitter 44 and the receiver 46 in the region of the outer ends of the displacement movement or, alternatively, of the arrangement of multiple transmitters 44 and receivers 46 are tilted, as shown in the bottom left region in FIG. 5. It should be understood that a corresponding tilting in the other direction may also be present at the opposite end of the straight line. As shown by means of the arrow 58 in FIG. 5, terahertz radiation reflected by the body in the region of a curve of the surface of the body can, in this way, also be received again by the receiver 46 and evaluated. As shown in the bottom left corner of FIG. 5 and illustrated by the arrow 60, this makes it possible to measure the rear side of the body of the person 12 that faces away from the transmitter 44 and/or receiver 46, namely in that terahertz radiation is reflected on the reflector 52 before reaching the rear surface of the body, is reflected again by the reflector 52 after being reflected on the surface of the body, and arrives back at the receiver 46. In this way, if the position and emission angle of the transmitter 44 and/or receiver 46 is known, the side of the body facing away from the transmitter 44 and/or receiver 46 can also be measured. A combined measurement would also be conceivable, in which the transmitter 44 and/or receiver 46 is moved once without tilting along the straight line in order to allow for a reliable measurement of the width of the body of the person 12, and is moved once along the straight line with relevant tilting at the end regions of the straight line. The same applies if multiple transmitters 44 and receivers 46 are arranged along the straight line. In this case, the transmitters 44 and receivers 46 in the outer region of the straight line may transmit and receive, respectively, once without tilting and once with tilting, for example.

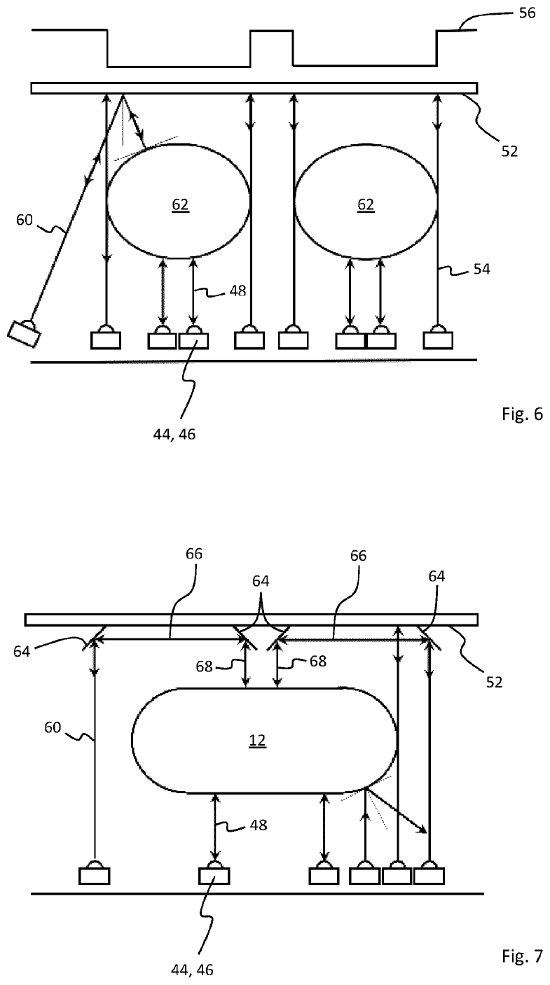

In FIG. 6, legs 62 of a person 12 are represented schematically. Based on the intensity curve 56, it can be seen how the width of the legs 62 as well as regions between the legs 62 can be reliably captured using the system shown in FIGS. 4 and 5. This accordingly also applies to further body measurements, such as the crotch height, width of the arms, armpit height, shoulder height, arm length, etc.

The exemplary embodiment shown in FIG. 7 largely corresponds to the exemplary embodiment according to FIG. 4. It differs on account of the presence of further reflectors 64 for terahertz radiation, which are arranged at an angle of 45° to the extension of the reflector 52 in such a way that some of the terahertz radiation passing the person 12 is directed onto the rear side of the person 12 facing away from the transmitter 44 and receiver 46, and arrive back at the transmitter 44 and receiver 46 after being reflected on the surface of the body of the person 12, as illustrated by the arrows 60, 66 and 68. This embodiment also makes it possible in a reliable manner to measure the rear side of the person 12 facing away from the transmitter 44 and receiver 46.

Furthermore, in all exemplary embodiments, it is possible for retroreflectors to be used as reflectors, as explained above.

### LIST OF REFERENCE SIGNS

10 Capturing region
12 Person
14 Transmitter
16 Transmitter
18 Transmitter
20 Receiver
22 Receiver
24 Receiver
26 Measuring column
28 Camera
30 Circular path
32 Evaluation apparatus
34 Measuring column
36 Measuring column
38 Measuring column
40 Measuring column
42 Reflector
44 Transmitter
46 Receiver
48 Arrow
50 Arrow
52 Reflector
54 Arrow
56 Intensity curve
58 Arrow
60 Arrow
62 Legs
64 Further reflectors
66 Arrow
68 Arrow

1-29. (canceled)

30. A method for capturing and providing data for a purchase of an item of clothing comprising:
irradiating a clothed person with terahertz radiation emitted from a transmitter for terahertz radiation;
reflecting the terahertz radiation from the clothed person;
receiving the reflected terahertz radiation by a receiver; and
determining body measurement data of the clothed person from the terahertz radiation received by the receiver.

31. The method of claim 30, further comprising:
receiving terahertz radiation emitted by the transmitter and passing the clothed person by at least one further receiver for terahertz radiation arranged opposite the transmitter; and
determining the body measurement data of the clothed person from the terahertz radiation received by the receiver and the terahertz radiation received by a further receiver.

32. The method of claim 30, further comprising:
emitting terahertz radiation by at least one further transmitter for terahertz radiation positioned opposite the transmitter, wherein the emitted terahertz radiation by the at least one further transmitter passes the clothed person;
receiving the terahertz radiation that passes the clothed person by the receiver; and
determining the body measurement data of the clothed person from the terahertz radiation received by the receiver.

33. The method of claim 32, further comprising:
reflecting at least some of the terahertz radiation emitted from the transmitter by a reflector positioned opposite the transmitter;
receiving terahertz radiation reflected by the reflector by the receiver; and
determining body measurement data of the clothed person from the terahertz radiation received by the receiver.

34. The method according to claim 30, further comprising:
reflecting at least some of the terahertz radiation by the reflector onto a side of the clothed person that faces away from the transmitter;
reflecting the at least some of the terahertz radiation by the clothed person;
receiving the at least some of the terahertz radiation reflected by the clothed person by the reflector;
reflecting the at least some terahertz radiation by the reflector; and
receiving the at least some terahertz radiation by the receiver after being reflected by the reflector.

35. The method according to claim 30, further comprising:
determining boundary lines of a body of the clothed using the body measurement data from the terahertz radiation received by the receiver.

36. The method according to claim 35, further comprising:
determining a movement of the body of the clothed person from a temporal change in the determined boundary lines of the body of the clothed person; and
determining body measurement data of the clothed person from the terahertz radiation received by the receiver and the determined movement of the body of the clothed person.

37. The method according to claim 30, wherein the determining of the body measurement data of the clothed person further comprises analyzing a diffraction pattern of the terahertz radiation diffracted at boundary lines of the body of the clothed person.

38. The method according to claim 30, further comprising identifying and suggesting an item of clothing in a suitable size with respect to the determined body measurement data and an input operator specification for the clothed person.

39. The method according to claim 38, further comprising determining alterations to the suggested item of clothing to be suggested to the clothed person based on the determined body measurement data in order to improve a fit of the suggested item of clothing on the clothed person.

40. The method according to claim 30, further comprising:
detecting a movement of the clothed person during the irradiation with terahertz radiation by detecting a frequency shift of the terahertz radiation received by the receiver; and which frequency shift is captured during the irradiation with terahertz radiation, and
determining body measurement data of the clothed person from the terahertz radiation received by the receiver and the detected movement.

41. The method according to claim 30, further comprising photographing a head of the clothed person by at least one camera.

42. The method according to claim 41, further comprising:
determining the body measurement data of the clothed person from the terahertz radiation received by the receiver and the photograph of the head; and
identifying and suggesting an item of clothing based on the determined body measurement data.

43. The method according to claim 41 further comprising:
creating a body model of the clothed person based on the determined body measurement data;
creating a visualization of the body model; and
representing the suggested item of clothing on the visualization of the body model.

44. The method according to claim 43, further comprising supplementing the visualization by the photograph of the head.

45. The method according to claim 44, wherein the visualization is configured to be at least one of: (i) rotated; (ii) displayed against different backgrounds; and (iii) displayed with different items of clothing being worn by the body model.

46. A system for capturing and providing data for a purchase of an item of clothing, comprising:
a transmitter configured to emit terahertz radiation onto a clothed person;
a first receiver configured to receive terahertz radiation reflected by the clothed person; and
an evaluation apparatus in communication with the receiver and configured to determine body measurement data of the clothed person based on the terahertz radiation received by the receiver.

47. The system of claim 46, further comprising a second receiver positioned opposite the first receiver and configured to receive terahertz radiation emitted by the transmitter and which passes the clothed person, wherein the evaluation apparatus is configured to determine body measurement data of the person from the terahertz radiation received by the receiver.

48. The system of claim 46 further comprising a second transmitter configured to emit terahertz radiation, wherein the second transmitter is arranged opposite the transmitter, wherein the receiver is further configured to receive the terahertz radiation emitted by the second transmitter that passes the clothed person, and wherein the evaluation apparatus is configured to determine body measurement data of the clothed person based on the terahertz radiation received by the receiver.

49. The system of claim 46, further comprising a reflector positioned opposite the transmitter, wherein at least some of the terahertz radiation emitted by the transmitter is reflected onto the reflector and then reflected from the reflector onto the first receiver, and wherein the evaluation apparatus is configured to determine body measurement data of the person from the terahertz radiation received by the first receiver.

50. The system according to claim 49, wherein the reflector is configured such that at least some of the terahertz radiation reflected by the reflector strikes a side of the clothed person that faces away from the transmitter, and wherein the at least some of the terahertz radiation is reflected by the clothed person to the reflector and then is reflected by the reflector and received by the receiver.

51. The system according to claim 47, wherein the evaluation apparatus is configured to determine boundary lines of the clothed body of the person using the body measurement data from the terahertz radiation received by the receiver or by the second receiver.

52. The system according to claim 51, wherein the evaluation apparatus is configured to detect a movement of the body of the clothed person by detecting a temporal change in the determined boundary lines of the body of the clothed person, and wherein evaluation apparatus is configured to determine the body measurement data of the clothed person based on the terahertz radiation received by the receiver and the detected movement.

53. The system according to claim 51, wherein the evaluation apparatus is further configured to analyze a diffraction pattern of the terahertz radiation diffracted at boundary lines of the body of the clothed person in order to determine the body measurement data of the person.

54. The system according to 53, wherein the evaluation apparatus is further configured to identify and suggest an item of clothing in a size that is suitable based on the determined body measurement data and an input operator specification.

55. The system according to claim 46, further comprising:
a plurality of transmitters configured to emit the terahertz radiation onto the clothed person; and
a plurality of receivers configured to receive terahertz radiation reflected by the clothed person, wherein each of the plurality of transmitters are arranged at different heights, and wherein each of the plurality of receivers are arranged at different heights relative to each other.

56. The system according to claim 54, further comprising:
a plurality of transmitters configured to emit the terahertz radiation onto the clothed person; and
a plurality of receivers configured to receive terahertz radiation reflected by the clothed person, wherein each of the plurality of the transmitters are arranged at different angular positions around a capturing region for the clothed person, and wherein each of the plurality of receivers are arranged at different angular positions around the capturing region for the clothed person.

57. The system according to claim 46, wherein the transmitter and the first receiver are configured to rotate around a capturing region for the clothed person.

58. The system according to claim 53, wherein the evaluation apparatus is further configured to determine alterations to the item of clothing based of the determined body measurement data in order to improve a fit of the item of clothing on the clothed person.

59. The system according to claim 46, wherein the evaluation apparatus is further configured to detect a movement of the clothed person during irradiation with terahertz radiation, wherein the movement is determined from a detected frequency shift of the terahertz radiation received by the receiver, wherein the evaluation apparatus further configured to determine the body measurement data of the clothed person based on the terahertz radiation received by the receiver and the detected movement.

60. The system according to claim 46, further comprising at least one camera configured to create a photo of a head of the clothed person.

61. The system according to claim 54, wherein the evaluation apparatus is further configured to determine the body measurement data of the clothed person based on the terahertz radiation received by the receiver and a photo created by a camera, and wherein the body measurement data is used to identify and suggest an item of clothing.

62. The system according to claim 54, wherein the evaluation apparatus is further configured to:
create a body model of the clothed person based on the determined body measurement data; and
create a visualization, wherein the visualization represents the item of clothing suggested to the clothed person in the state worn by the body model.

63. The system according to claim 62, further comprising supplementing the visualization with the photo of the head of the clothed person.

64. The system according to claim 62, wherein the visualization and the body model is configured to at least one of: (i) rotate; (ii) be displayed against different backgrounds; and (iii) display further items of clothing in addition to the item of clothing suggested to the clothed person in a state worn by the body model.
